(19) United States
(12) Patent Application Publication
(10) Pub. No.: US 2018/0216468 A1
(43) Pub. Date: Aug. 2, 2018

(54) BLADE CONTOUR OF A ROTOR FOR A LIQUID RING PUMP

(71) Applicant: GARDNER DENVER NASH LLC, Charleroi, PA (US)

(72) Inventors: Wilson Fabián GAIBOR, Belle Vernon, PA (US); Giovanni ZAZA, Milano (IT); Emanuele ROTTA, Buccinasco (IT)

(21) Appl. No.: 15/748,825

(22) PCT Filed: Oct. 14, 2015
(86) PCT No.: PCT/US15/55515

§ 371 Date: Jan. 30, 2018

Related U.S. Application Data
(60) Provisional application No. 62/198,898, filed on Jul. 30, 2015.

(51) Int. Cl. F01D 5/14; F04C 19/00; F04D 17/18

(52) U.S. Cl. CPC F01D 5/141; F04C 19/00; F04D 17/18; F05B 2250/71; F04C 2250/20; F05B 2250/184; F04C 2240/20

(57) ABSTRACT

A liquid ring pump includes a stationary housing that defines an inner space, and a drive shaft rotatably mounted within the stationary housing. The drive shaft defines a rotational axis. An impeller includes a plurality of blades extending radially outward with respect to the rotational axis, and each blade includes a root and a tip, wherein a continuous curve extends from the tip of each blade through the root of the blade and intersects with the rotational axis.

### BACKGROUND

The present invention relates to liquid ring pumps. Specifically, the present invention relates to a rotor of a liquid ring pump.

Conventionally, liquid ring pumps are used to pump or compress gaseous matter, and include a housing and a rotor rotationally supported in the housing. The rotor is mounted to a drive shaft within the housing and includes a plurality of blades. A chamber (i.e., a void space) between adjacent blades receives and discharges gaseous matter from an inlet aperture to an outlet aperture of the housing, respectively. As gaseous matter is drawn into the chamber through the inlet aperture of the housing, the gaseous matter is compressed in the chamber during rotation toward the outlet aperture and expelled from the chamber through the outlet aperture of the housing.

### SUMMARY

In one aspect, the invention provides a liquid ring pump including a stationary housing that defines an inner space, and a drive shaft rotatably mounted within the stationary housing. The drive shaft defines a rotational axis, and an impeller including a plurality of blades extends radially outward with respect to the rotational axis. Each blade includes a root and a tip, such that a continuous curve extends from the tip of each blade through the root of the blade and intersects with the rotational axis.

In another aspect, the invention provides a liquid ring pump including a stationary housing that defines an inner space, and an inner wall coupled to the stationary housing. The inner wall includes an inlet aperture and an outlet aperture. A drive shaft is rotatably mounted within the stationary housing and defines a rotational axis. An impeller is secured to the drive shaft and includes a first blade extending radially outward from the rotational axis and defining a first tip. The impeller includes a second blade extending radially outward from the rotational axis opposite the first blade and defining a second tip. The first blade and the second blade lie on a continuous curve in a plane normal to the rotational axis that extends from the first tip to the second tip.

In another aspect, the invention provides a blade for a liquid ring impeller. The blade including a root, a tip opposite the root, and a body extending between the root and the tip. A continuous curve extends from the tip of each blade through the root of the blade and intersects with a rotational axis of the impeller. The continuous curve is a sinusoidal-like curve.

Other aspects of the invention will become apparent by consideration of the detailed description and accompanying drawings.

### BRIEF DESCRIPTION OF THE DRAWINGS

FIG. 1 is an exploded perspective view of a liquid ring pump.

FIG. 2 is a perspective view of a rotor of the liquid ring pump of FIG. 1.

FIG. 3 is a cross-sectional side view of the rotor of FIG. 2 taken along line 30 of FIG. 4.

FIG. 4 is a side view of the rotor of FIG. 2.

FIG. 5 is a cross-sectional front view of the rotor along section line 5-5 of FIG. 4.

FIG. 6 is a cross-sectional front view of a rotor according to another embodiment.

FIG. 7 is a cross-sectional front view of a rotor according to yet another embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof Unless specified or limited otherwise, the terms “mounted,” “connected,” “supported,” and “coupled” and variations thereof are used broadly and encompass both direct and indirect mountings, connections, supports, and couplings.

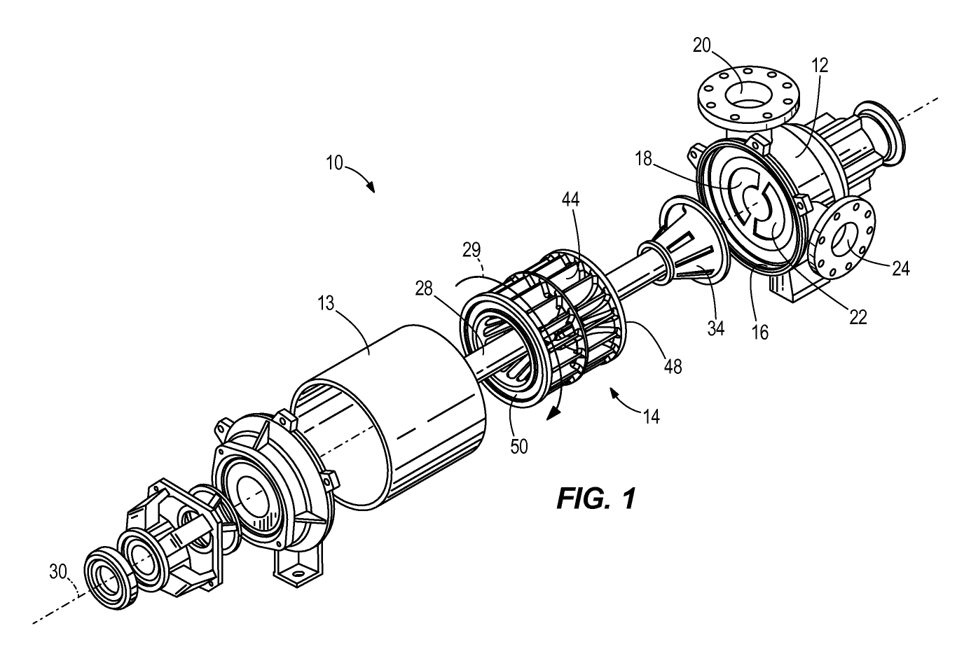

FIG. 1 illustrates a pump, such as a liquid ring pump 10 of the present invention. The liquid ring pump 10 of the illustrated embodiment is a single-stage liquid ring pump including an end plate 12 and a housing 13 adjacent to the end plate 12. The end plate 12 supports a prime mover (not shown) and a rotor 14. In other embodiments, the liquid ring pump 10 may be a multi-stage liquid ring pump such that one or more rotors 14 may cooperate in parallel or series as desired.

The end plate 12 includes an inner wall 16 having an inlet port 18 in fluid communication with a gas inlet 20, and an outlet port 22 in fluid communication with a gas outlet 24. The liquid ring pump 10 operates, for example, as a pump when the gas inlet 20 is the working end. In this case, the gas inlet 20 is a vacuum (i.e., below atmospheric pressure), whereas the gas outlet 24 is substantially at atmospheric pressure or higher. Alternatively, the liquid ring pump 10 operates, for example, as a compressor when the gas outlet 24 is the working end. In this case, the gas inlet 20 is typically at atmospheric pressure, whereas the gas outlet 24 is at a pressure greater than atmospheric pressure. Therefore, the gas inlet 20 is at a lower pressure compared to the gas outlet 24 in each application. As one of ordinary skill in the art will understand, the terms “compressor” and “pump” are largely interchangeable.

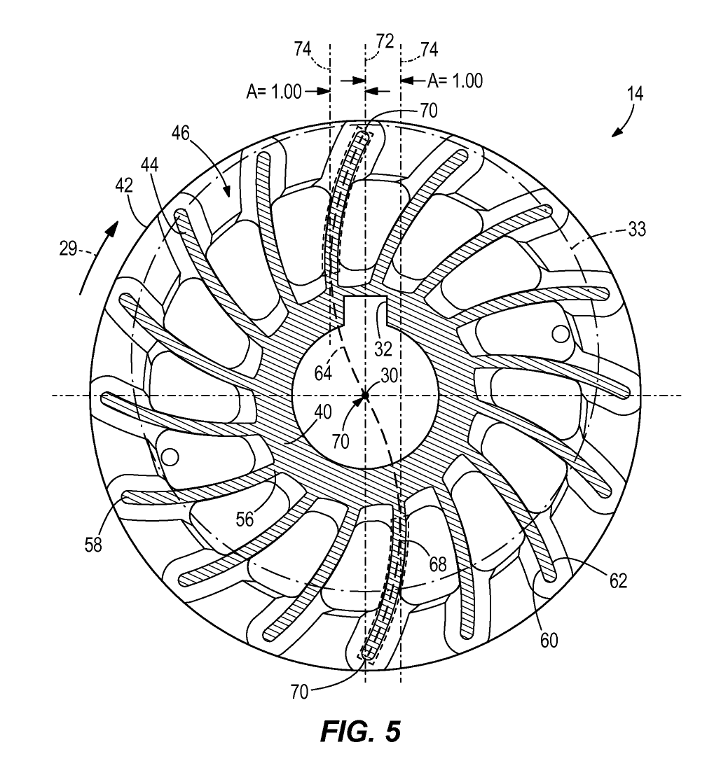

The end plate 12 of the illustrated embodiment rotationally supports a drive shaft 28. The rotor 14 is coupled to the drive shaft 28 for co-rotation in a clockwise direction 29 about a rotational axis 30 (e.g., via a keyed coupling 32). Specifically, the drive shaft 28 is eccentrically positioned relative to the housing 13 such that when the housing 13 is partially filled with pumping liquid (e.g., water), the rotating rotor 14 engages the pumping liquid and causes the pumping liquid to form an eccentric ring of recirculating liquid in the housing 13 relative to the rotor 14 (FIG. 5). The ring of recirculating liquid is commonly referred to as a liquid ring 33 (shown in FIGS. 5-7). A frusto-conical port member 34 is disposed adjacent to the inner wall 16 of the end plate 12 and at least partially received within the rotor 14. The frusto-conical port member 34 facilitates fluid communication between the rotor 14, and the inlet and outlet ports 18, 22. Although the illustrated end plate 12 is configured to support the conical rotor 14, in other embodiments the end plate 12 may be configured to support a flat-plate rotor that cooperates with a flat port plate rather than the conical port member 34 to facilitate flow between the inlet 20 and the outlet 24. Furthermore, the rotor 14 may rotate in a counterclockwise direction in other embodiments.

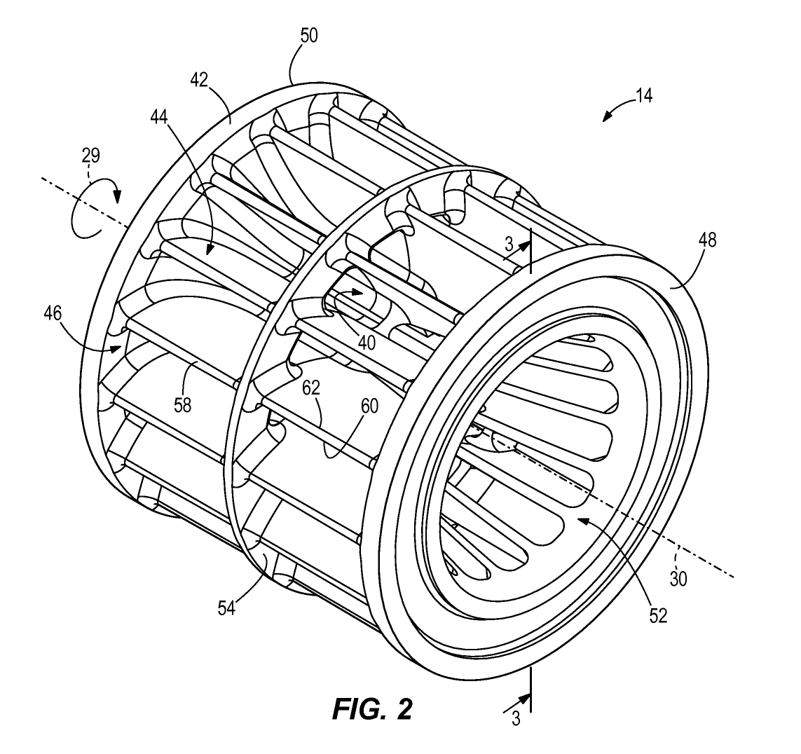

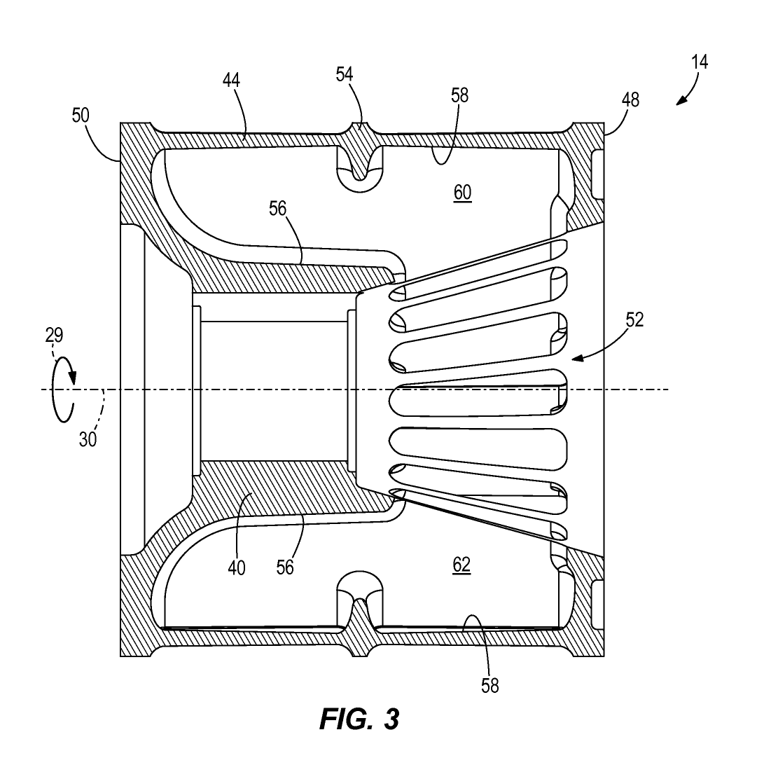

With reference to FIG. 2, the rotor 14 includes a central hub 40, a rim 42, and a plurality of blades 44 extending between the central hub 40 and the rim 42. In particular, the plurality of blades 44 are angularly spaced at regular intervals around the central hub 40 and extend radially outward with respect to the rotational axis 30 of the rotor 14. Between the hub 40, the rim 42, and each blade 44 of the rotor 14 is a chamber 46. The chamber 46 is a constantly varying volumetric space due to the eccentric liquid ring 33 surrounding the rotor 14. The rotor 14 further includes a first end 48 and a second end 50 defining an axial length of the rotor 14 therebetween. The first end 48 includes a frusto-conical space 52 (best illustrated in FIG. 3) that at least partially receives the frusto-conical port member 34. The frusto-conical space 52 is concentric with the shaft 28 and converges toward the central hub 40. Disposed mid-way between the first end 48 and the second end 50 of the rotor 14 is an annular disk 54 that stiffens the rotor 14, and more specifically each blade 44. In other embodiments, the second end 50 may include the frusto-conical space 52 to at least partially receive a seperate frusto-conical port member similar to the port member 34.

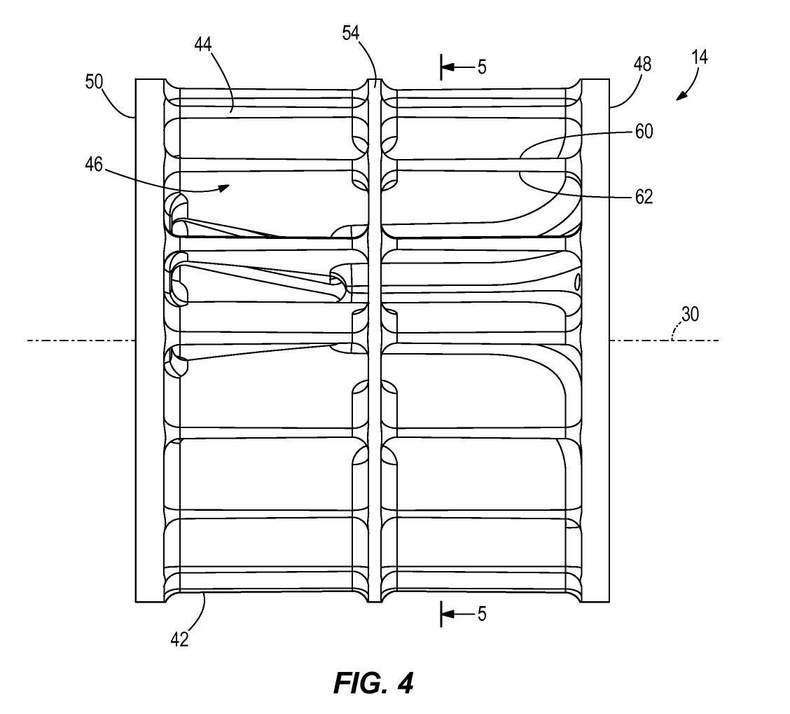

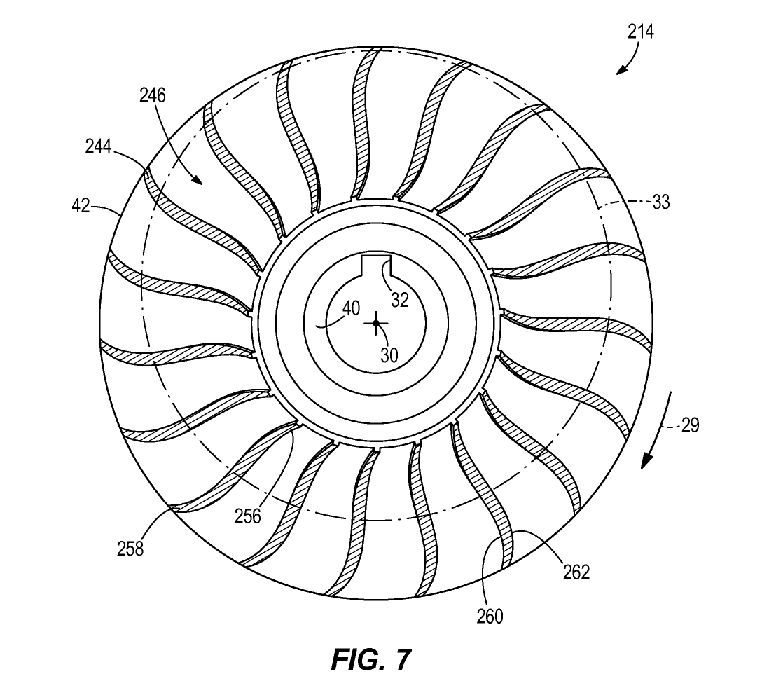

In the illustrated embodiment, each blade 44 of the rotor 14 has a length extending substantially between the first end 48 and the second end 50 of the rotor 14 (FIG. 4). A height of each blade 44 is defined by the distance between a root 56, which is adjacent to at least one of the central hub 40 and the frusto-conical space 52, and a tip 58, which is opposite the root 56 adjacent to the outer periphery of the rim 42 (FIG. 5). Additionally, a thickness of each blade 44 is defined by the distance between a first face 60 of each blade 44 and a second face 62 of each blade 44 opposite the first face 60. When the rotor 14 is rotating in the clockwise direction 29, the first face 60 is forwardly disposed, whereas the second face 62 is rearwardly disposed. Each blade 44 is of generally uniform thickness (i.e., plus or minus 10 percent) between the first face 60 and the second face 62 along the height of each blade 44. While the illustrated blades 44 include a substantially uniform thickness along the height, other constructions may include variable thickness along the height (e.g., FIG. 7).

With reference to FIG. 5, each blade 44 of the rotor 14 defines a sinusoidal-like curve 64 such that a continuous curve extends from the tip 58 of each blade 44 through the root 56 of each blade 44 and intersects with the rotational axis 30. By definition, a sine curve (i.e., sinusoidal) refers to the curve produced by the mathematical relationship of y=Asin(x), (where “A” is the amplitude of the curve) and is a graphic representation of the ratio of the size of an angle to its sine. For clarification, the sinusoidal-like curve 64 exhibits similar characteristics of a mathematical sine curve, but does not necessarily coincide with a curve produced by the mathematical relationship of y=Asin(x).

The sinusoidal-like curve 64 includes one full cycle (i.e., one period) extending from the tip 58 of one of the plurality of blades 44 to the tip 58 of an opposite one of the plurality of blades 44 in a plane normal to the rotational axis 30 (i.e., the plane of Section A-A). Conventionally, one period of a sinusoidal-like curve has a crest 66, a trough 68, and three regularly spaced points 70 along the curve 64 that intersect a common axis 72. As illustrated, these three points 70 reside at the tip of each of the opposed blades 44, and at the rotational axis 30 of the rotor 14. As shown in FIG. 5, each blade 44 further defines an amplitude of approximately 1.0, which is a measure of the maximum deviation (i.e., the crest 66, and the trough 68) from the common axis 72. Specifically, the amplitude is a measure of the perpendicular distance between the common axis 72 and a parallel axis 74 tangent to the crest 66 or the trough 68 of each blade 44.

In the illustrated embodiment of FIG. 5, the first face 60 of each blade 44 has a concave surface disposed between the root 56 and the tip 58. Conversely, the second face 62 of each blade 44 has a convex surface disposed between the root 56 and the tip 58. The spacing at regular intervals of each blade 44 around the central hub 40 assures that when the rotor 14 is rotating in the clockwise direction 29, the tip 58 of each blade 44 extends forward of a virtual straight line which lies within a plane normal to the rotational axis 30 that intersects the rotational axis 30 and the root 56 of the adjacent blade 44.

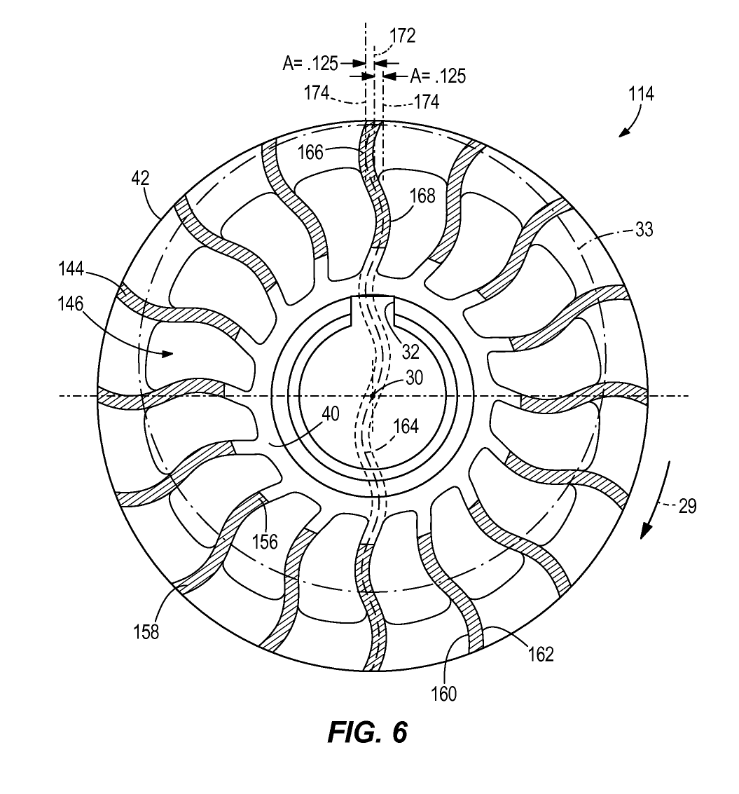

FIG. 6 illustrates a rotor 114 according to an alternative embodiment. Similar to the rotor 14 of FIG. 5, the rotor 114 includes a plurality of blades 144 which also define a sinusoidal-like curve 164 that extends from a tip 158 of each blade 144 through a root 156 of the blade 144 and intersects with the rotational axis 30. Once again, the sinusoidal-like curve 164 exhibits similar characteristics of a mathematical sine curve, but does not necessarily coincide with a curve produced by the mathematical relationship of y=Asin(x). In this embodiment, each blade 144 includes four full periods of the sinusoidal-like curve 164 extending from the tip 158 of one of the plurality of blades 144 to the tip 158 of an opposite one of the plurality of blades 144 in a plane normal to the rotational axis 30 (i.e., the plane of Section A-A). As a result, a first face 160 and a second face 162 of each of the plurality of blades 144 have a concave surface and a convex surface disposed between the root 156 and the tip 158. In this case, each blade 144 further defines an amplitude of approximately 0.125 measured by the perpendicular distance between a common axis 172 and a parallel axis 174 tangent to a crest 166 or a trough 168 of each blade 144.

As with the construction of FIG. 5, the blades 144 of FIG. 6 follow a sinusoidal-like curve that is continuous in the mathematical sense (i.e., follows a non-linear curve in which small changes in the “y” value result in small changes in the “x” values with no sudden changes in slope) from the tip of each blade, through the rotational axis to the tip of an opposite blade.

FIG. 7 illustrated a rotor 214 according to another embodiment. The rotor 214 includes similar features to the rotors 14, 114 of FIGS. 5 and 6 having a plurality of blades 244 extending radially outward that include a root 256, a tip 258, a first face 260, and a second face 262. In this embodiment, the thickness of each blade 244 is non-uniform along the height of each blade 244. For example, the thickness of each blade 244 narrows at the root 256 and the tip 258, such that the first face 260 and the second face 262 converge toward each other proximate the root 256 and the tip 258.

As shown in FIG. 7, each blade 244 extends between the central hub 40 and the rim 42 of the rotor 214, and extends along a curve that lies within a plane normal to the rotational axis 30. The first face 260 and the second face 262 of each of the blades 244 have a concave surface and a convex surface disposed between the root 256 and the tip 258. In this embodiment, the curve that each blade 244 extends along does not intersect with the rotational axis 30.

Thus, the construction of FIG. 7, like the constructions of FIGS. 5 and 6 includes blades that follow a continuous non-linear curve from their root to their tip. However, unlike the constructions of FIGS. 5 and 6, the curves followed by the blades of FIG. 7 do not extend and remain continuous across the rotational axis 30 of the rotor 214 to an opposite blade 244. The curved portion near the root 256 of the blades 244 changes the flow angle of the gas, thereby decreasing friction and turbulence and enhancing pressure recovery.

In operation, the rotor 14, 114, 214 is rotated within the housing 13 as the prime mover is activated to produce the liquid ring 33. In response to activation of the prime mover, the chambers 46, 146, 246 act as a rotating piston to draw gaseous matter at a first pressure from the inlet port 18 and corresponding gas inlet 20. Specifically, the gaseous matter is drawn into the chambers 46, 146, 246 due to the receding liquid ring 33 proximate to the inlet port 18. The frusto-conical member 34 facilitates flow (e.g., intake flow and discharge flow) of gaseous matter through the frusto-conical member 34 and the rotor 14 between the inlet port 18 and outlet port 22 of the inner wall 16.

As each chamber 46, 146, 246, in turn, rotates past the inlet port 18, the gaseous matter is subsequently confined between the liquid ring 33, the hub 40, the first face 60, 160, 260 of one of the blades 44, 144, 244 and the second face 62, 162, 262 of one of the adjacent blades 44, 144, 244. As the rotor 14, 114, 214 continues to rotate in the clockwise direction 29, the volumetric space inside the chamber 46, 146, 246 decreases as the liquid ring 33 approaches the hub 40 and the gaseous matter confined within the chamber 46, 146, 246 is compressed to a second pressure greater than the first pressure. When each chamber 46, 146, 246, in turn, rotates past the outlet port 22, the gaseous matter is subsequently discharged from the chamber 46, 146, 246 through the gas outlet 24 via the outlet port 22. As a result, flow of the gaseous matter through the gas outlet 24 is continuous and without pulsation.

The rotor 14, 114, 214 including a plurality of blades having a sinusoidal-like continuous curve (or another continuous curve) of the above description provides advantages in terms of efficiency gains as a result of friction reduction, especially at high vacuum and high speed applications. The increased efficiency gains extend the working range of the single-stage liquid ring compressor/pump to applications currently operated with a multi-stage liquid ring compressor/pump, reduce costs, and allow for greater flexibility of use. Typically, the single-stage liquid ring compressors/pumps can be advantageous as they allow some flexibility in terms of inlet pressure and flow rate.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention.

Various features of the invention are set forth in the following claims.

1. A liquid ring pump, comprising:
a stationary housing that defines an inner space;
a drive shaft rotatably mounted within the stationary housing, the drive shaft defining a rotational axis; and
an impeller including a plurality of blades extending radially outward with respect to the rotational axis, each blade includes a root and a tip, wherein a continuous curve extends from the tip of each blade through the root of the blade and intersects with the rotational axis.

2. The liquid ring pump of claim 1, wherein each one of the plurality of blades define a sinusoidal-like curve.

3. The liquid ring pump of claim 1, wherein each blade is of uniform thickness between the root and the tip in a plane normal to the rotational axis.

4. The liquid ring pump of claim 1, further comprising a first face and a second face of each blade extending between the root and the tip, the first face is concave and forward of the second face as the impeller rotates in a clockwise direction, the second face is convex and is trailing the first face as the impeller rotates in a clockwise direction.

5. The liquid ring pump of claim 1, wherein the tip of each blade extends forward in a clockwise direction of a virtual line extending through the rotational axis and the root of the adjacent blade.

6. The liquid ring pump of claim 4, wherein the first face and the second face of each blade has a concave portion and a convex portion extending between the root and the tip.

7. The liquid ring pump of claim 6, wherein the first face and the second face of each blade has a substantially straight portion interposed between the concave portion and the convex portion.

8. The liquid ring pump of claim 2, wherein one cycle of the sinusoidal-like curve extends from the tip of each blade to the tip of each opposing blade.

9. The liquid ring pump of claim 8, wherein each blade defines an amplitude of approximately 1.0 scale unit defined by the distance between a plane extending through the rotational axis and the tip of the blade to a parallel plane extending tangent through a crest of the sinusoidal-like curve of the corresponding blade.

10. The liquid ring pump of claim 6, wherein four cycles of the sinusoidal-like curve extends from the tip of each blade to the tip of each opposing blade.

11. The liquid ring pump of claim 10, wherein each blade defines an amplitude of approximately 0.125 scale unit defined by the distance between a plane extending through the rotational axis and the tip of the blade to a parallel plane extending tangent through a crest of the sinusoidal-like curve of the corresponding blade.

12. A liquid ring pump, comprising:
a stationary housing that defines an inner space;
an inner wall coupled to the stationary housing and including an inlet aperture and an outlet aperture;
a drive shaft rotatably mounted within the stationary housing, the drive shaft defining a rotational axis; and
an impeller secured to the drive shaft and including a first blade extending radially outward from the rotational axis and defining a first tip and a second blade extending radially outward from the rotational axis opposite the first blade and defining a second tip, the first blade and the second blade lying on a continuous curve in a plane normal to the rotational axis that extends from the first tip to the second tip.

13. The impeller of claim 12, wherein the inner wall is a flat wall.

14. The impeller of claim 12, wherein the inner wall is a conical-shaped wall.

15. The impeller of claim 12, further comprising a first face and a second face of each blade, the first face is forward of the second face as the impeller rotates in a clockwise direction, and the second face is trailing the first face as the impeller rotates in a clockwise direction.

16. The impeller of claim 12, wherein the tip of each blade terminates at the outer periphery of a rim of the impeller.

17. The impeller of claim 12, further comprising a bucket defined by the space between the first face, the second face, and the outer periphery of the rim.

18. The impeller of claim 17, wherein the inlet aperture introduces fluid into the bucket at a first pressure, and fluid is discharged from the bucket to the outlet aperture at a second pressure higher than the first pressure.

19. The liquid ring pump of claim 12, wherein the continuous curve is a sinusoidal-like curve.

20. A blade for a liquid ring impeller, the blade comprising:
a root;
a tip opposite the root; and
a body extending between the root and the tip, wherein a continuous curve extends from the tip of each blade through the root of the blade and intersects with a rotational axis of the impeller, wherein the continuous curve is a sinusoidal-like curve.
